(19) United States
(12) Patent Application Publication
(10) Pub. No.: US 2005/0247480 A1
(43) Pub. Date: Nov. 10, 2005

(54) Self winding electric cord

(76) Inventor: Steven Mark Schulz, Baton Rouge, LA (US)

Correspondence Address: Steven Schulz, 13336 Avants Avenue, Baton Rouge, LA, 70815, US

(21) Appl. No.: 10/838,412

(22) Filed: May 4, 2004

(51) Int. Cl. H01B 7/29

(52) U.S. Cl. 174/117 FF

(57) ABSTRACT

An electric cord utilizing flat strip metal under tension to simplify rewinding the cord. The apparatus comprises a spring biased metal clad within a non-conducting sheath. The spring-loaded metal is biased to effect a concave surface in the general axis congruent to the extreme or long axis. The preloaded spring metal coils in its natural state. The embodiment of the invention locates multiple strips of spring metal in a parallel configuration. The apparatus confines the linear metal strips within a plastic or alternate non-conductor sheath configured to bend or distort the apparatus parallel to the long axis. The apparatus can then be distorted along the major axis to counteract the spring tension delaying the natural coiling of the electric cord. In a basic embodiment the distortion is applied by folding the electric cord along the major axis producing a ridged configuration and resisting the spring from coiling. Reversing the distortion by unfolding the electric cord recreates the spring tension and promotes the self-coiling action.

### REFERENCES CITED

| | | | |
|---|---|---|---|
| 3410023 | November 1968 | Anello | |
| 3966121 | June 1976 | Littman | 239/197 |
| 4153189 | May 1979 | Hughes | 294/143 |
| 4262385 | April 1981 | Norman | 294/149 |
| 4402542 | September 1983 | Kreutzer | 294/156 |
| 4582257 | April 1986 | Siegler | 239/197 |
| 4706914 | November 1987 | Ground | 24/447 |
| 4724548 | February 1988 | London | 63/11 |
| 4796936 | January 1989 | Sherin | 294/148 |
| 5176452 | January 1993 | Stern | 446/486 |
| 5607107 | March 1997 | Grieve | 239/195 |
| 5738398 | May 1996 | Miano | 294/L1 |
| 5971612 | October 1999 | McAuslan | 383/43 |

### BACKROUND OF INVENTION

1. Field of the Invention

The present invention relates to an electric cord designed to be self winding and self storing. The effective coiling and wrapping of such flexible electric cords is desirable from both appearance and safety standpoints. Tangled cords pose a hazard in any workplace as well as an inconvenience in sorting and storing said devices. A need is realized for the development of a simple method of uncoiling the extension cord and the subsequent recoiling of the extension cord. The ease of storage is desirable to prevent interference with persons working, standing or working in close proximity to such cords.

2. Description of Prior Art

In general, electric cords have been in use for a number of years. The cords are generally long sections of wire encased in a plastic or rubber sheath. In operation, the electric cord is generally extended to its total length creating a path for the electric current at the remote site of interest. The electric cords typically have a male and female electric plug attached to either end. During operation, the cords become twisted and tangled creating a problem during storage. Once the cords are hand coiled, the tendency for tangling becomes acute. The more use the electric cord receives the greater the tendency to tangle.

In its most common embodiment the electric cord is a loose bundle of insulated wires stretched to its length in the active configuration then rewound when not in use. A major drawback to this basic design is the difficulty with winding and deploying the cord for active use. The natural tendency of electric cords to twist creates an increasingly difficult storage and deployment situation. In addition to difficulty associated with storage there is significant tendency to create tears and gaps in the insulation due to manhandling of the cords.

One improvement to the basic design is the addition of a winding spool. There are various embodiments that utilize forms and spools for winding and unwinding the electric cord. A disadvantage that is not addressed using a reel as a take up devise involves the same tendency to tangle. Commonly the wire becomes twisted and becomes difficult to wind with or without a mandrel. Another drawback is the coupling of the plug on the fixed side of the moving reel. The motion of the reel exacerbates the tendency of the plug to become lose or short circuited. Another drawback is the bulkiness of the mechanism. The nature of the reel creates a larger and bulkier device creating a problem once its deployed. The reel remains fixed in most cases creating a much larger footprint during storage and creating a tripping hazard while the cord is in use.

In cases where the reel is detached during operation the vacant take up reels pose the same hazard becoming another object to avoid at a work site. Another problem associated with detachable reels is the degree of difficulty associated with attaching and de-attaching the cord to the reel. Among the most common problems with detachable reels is the tendency to misplace and damage the reel while the cord is in use.

Therefore, while electric cords wound on reels are known in the prior art, all of the known prior art embodiments contain the disadvatanges set forth above. Loose wound cords utilizing straps, clips and other restraints designed to secure electric cords in prior art, which further creates the disadvatanges described above.

### SUMMARY OF THE PRESENT INVENTION

The present invention relates to a novel design for a self-winding electric cord. The novel design of the cord eliminates the need for separate reels to wind the cord. What is provided is an apparatus that transmits electric current as the need arises by unrolling the cord to its expanded length, then it simply rewinds to a compact state when not in use. The apparatus generally comprises of self rolling spring strips encased in insulation and a pair of fastening means fixedly attached to the inside and outside surfaces of the strip such that when the cord is in the coiled position, the fastening means prevents the cord from unwinding. The cord with the spring steel enclosed are biased to a coiled position and when uncoiling the cord is to be folded along its long axis in a predetermined flex joint acting as a hinge. Once manually flexed along this hinged axis the cord remains in a straightened configuration until re-flattened for coiled storage.

In operation the cord is initially in a coiled stored condition, the apparatus is then manually opened and creased along its long axis, this folding action negates the biased coiling tendency of the spring steel to re-coil prematurely. Once the cord is extended to its full length in this folded condition the cord remains in this stable state for the duration of use. While in operation the extended cord is substantially uncoiled and able to be manipulated to traverse any open space enabling power to be transmitted to remote locations. Once the Electric cord is no longer needed the cord is unflexed at the linear hinge; in other words it is flattened, allowing the natural spring bias to help it re-coil. An additional help in keeping the cord in a neatly wound coil is the hinged center of the cord, it protrudes slightly on its bottom side when the cord is in its flat configuration, it also is slightly recessed on the top side, allowing the cord to mate with itself when coiled. The addition of fastening means creates a secure method of keeping the coil in position when stored in a coiled position.

In view of the above, it is an object of the present invention to provide an apparatus that can extend to provide power when needed and be simply recoiled for storage without the problems associated with normally twisted round cords.

It is a further object of the present invention to provide such an apparatus for the compact storage of electric cords and ease of recoiling which is simple in design and economical to manufacture.

### BRIEF DESCRIPTION OF THE DRAWING

For a further understanding of the nature and objects of the present invention, reference should be had to the following description taken in conjunction with the accompanying drawing in which like parts are given like reference numerals and wherein:

FIG. 1 is a front perspective view of the preferred embodiment of the apparatus of the present invention in a partially coiled position;

FIG. 2 is a partial front perspective view of the preferred embodiment of FIG. 1 in a folded and extended position;

FIG. 3 is a close up perspective view of the preferred embodiment similar to FIG. 1, with a magnified blowup;

FIG. 4 is a side view of the preferred embodiment of the apparatus;

FIG. 5 is a cross section view taken at a point along the length of the preferred embodiment.

### DETAILED DESCRIPTION OF THE PREFERRED EMBODIMENT

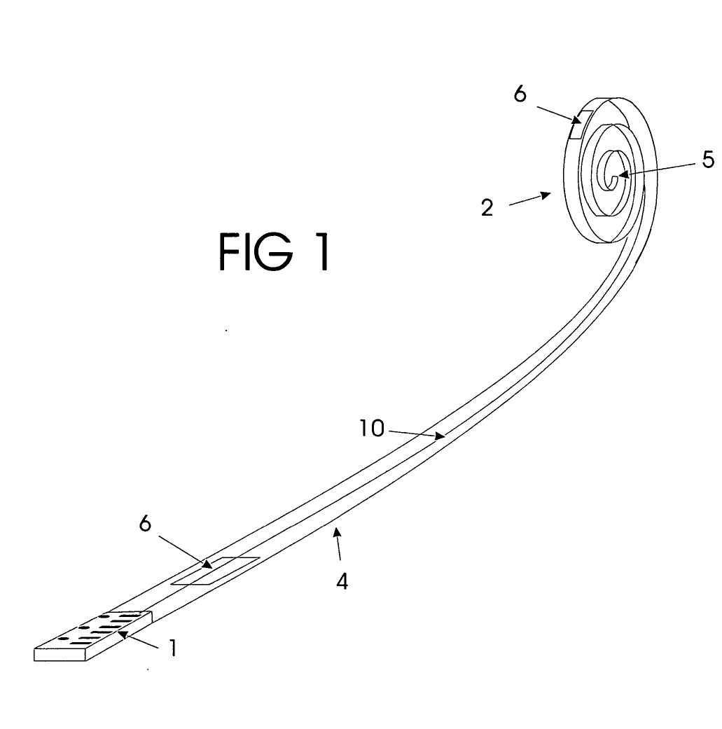

Referring now to the drawing and in particular FIGS. 1-3, The apparatus of the present invention is designated generally by the numeral 4. Apparatus 4 is generally comprised of self-rolling spring strips C, enclosed by insulation layer D, with fastening means 6, which are fixedly attached to strip 11.

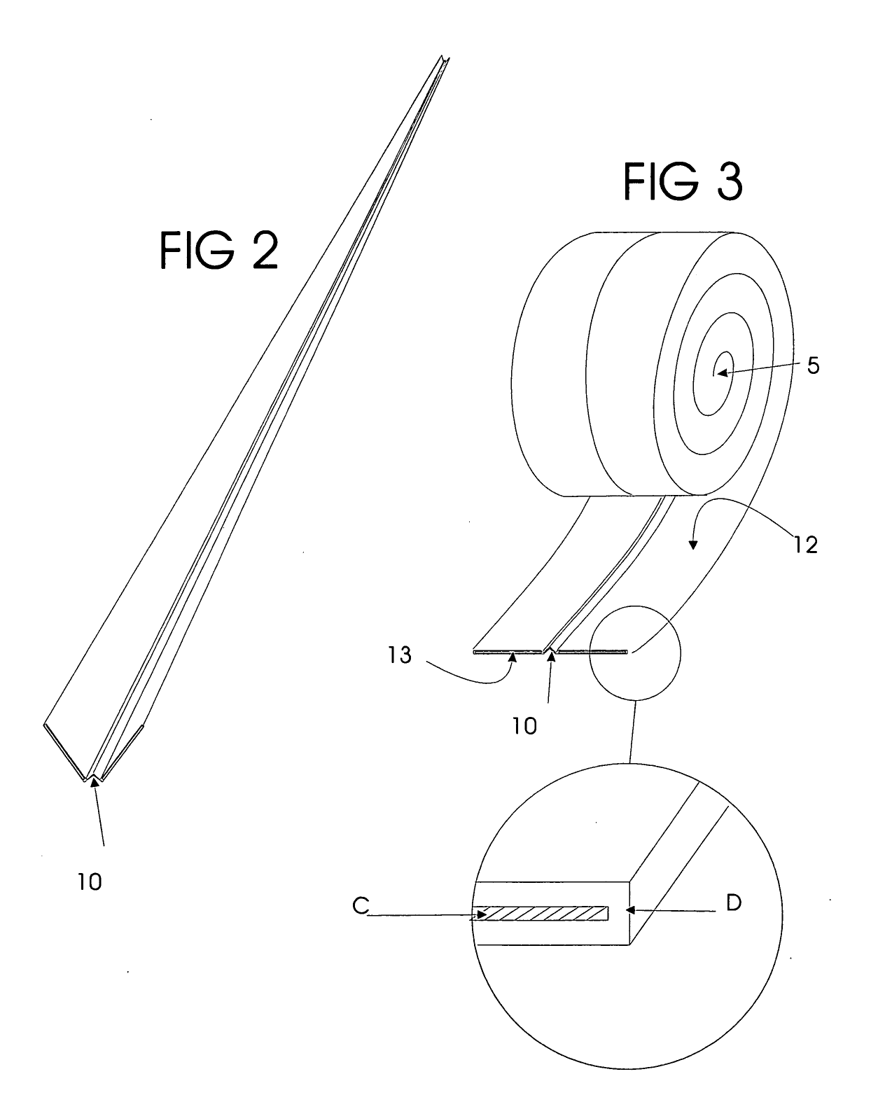

Spring strip C, is known in the art and is commonly used in steel roll tape measures. Spring strip C has a bias to remain in a coiled state, the coiled steel is sheathed in an insulating layer D. The sheathing is extruded in a segmented shape with a hinged segment 10. Said strip is in a substantially rectangular shape and preferably elongated, as best seen in FIG. 2.

Fastening means 6, are preferably hook and loop type fasteners such as “VELCRO”. Fastening means 6 is preferably hook type fasteners fixedly attached to surface D, as seen in FIGS. 1 and 3. Fastening means 6 are substantially rectangular in shape and positioned along the length in such a manor as to mate when in the coiled position.

Referring now to FIG. 1, the apparatus is shown partially un-coiled. Each end of the apparatus is equipped with a plug 5, and a receptacle 1, allowing for use as an electrical cord. The coil when in the wound configuration remains in this state by utilizing the fastening means 6 that contact upon winding. Another condition creating the coiling bias are the spring strips seen in FIG. 3, referred to as C. These strips are pre-biased to create a coiled condition. The spring strip C, could be metal but other materials will work. A preferred embodiment utilizes the spring strip C, and takes advantage of a metal spring strip C, to transmit an electric current. Referring to FIG. 3, the coil is further helped to wind in a compact form through the mating of the hinge 10, designed to be affixed to the coil spring C. Referring to FIG. 5, the hinge 10, protrudes slightly from side 12 and once in the coiled position, side 12 rests against side 13 and creates a tongue and groove affect at the hinge 10 crease.

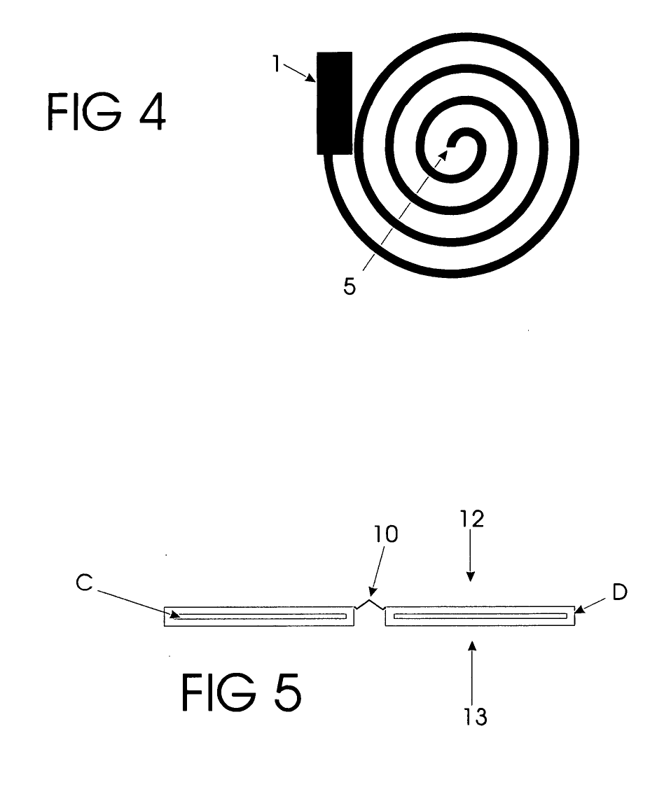

Further referring to FIGS. 1, 3, and 5, showing the flat nature of the apparatus as specifically as seen in FIG. 5, the cross section is flat allowing the natural bias of the spring strip C to coil upon itself. Once in the coiled position depicted by FIG. 4, the apparatus is in a compact form and can be stored in this form without fear of unwinding due to the aforementioned provisions.

Referring to FIG. 2 a segment of said apparatus is shown in a folded configuration. Once the apparatus is bent along hinge point 10, to create tension at a right angle to the natural coiling tendency associated with the spring C. The hinge 10 allows the long axis to fold and straighten the natural coiling tendency. The apparatus can then be un-coiled to its full length while in use. While the apparatus is in a folded configuration it remains stable in an uncoiled position enabling use as an extension cord.

Once the apparatus is ready for storage the cycle can be reversed by flattening the fold as seen in FIG. 5, and re-establishing the coiling effect and allowing the apparatus to re-coil as depicted in FIG. 1, section 2.

As can be seen from the drawing and above description, the apparatus of the present invention is simple in design, requiring only a few parts. Furthermore, the apparatus is made simply with ordinary inexpensive items, thus being easy and economical to manufacture.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

1. An apparatus for conveying an electric current that is self winding, comprising:
(a) Self-coiling spring strips of metal biased to a coiled position subject to an unwound condition upon manipulation of a foldable membrane integrally designed into the encapsulated structure housing the apparatus.

2. The apparatus of claim 1, wherein said strip is substantially attached to a receptacle acting to mate said strip with any common electric plug.

3. The apparatus of claim 2, wherein said strip is substantially attached to a plug acting to mate said strip with any common electric receptacle.

4. The apparatus of claim 3, wherein said strip is sheathed in a non conductor or insulator.

5. The apparatus of claim 4, wherein said sheathed strip is extruded with a design to allow a natural fold to occur at a substantially reduced force.

6. The apparatus of claim 5; wherein said sheathed strip is able to fold parallel to the long axis.

7. The apparatus of claim 6, an embodiment that includes a pair of hook and loop fasteners fixedly attached on said opposing surfaces such that when said strip is in a coiled position, said fasteners prevent said strip from unwinding.

8. The apparatus of claim 6, an embodiment that includes a friction fastener fixedly attached on said opposing surfaces such that when said strip is in a coiled position, said fasteners prevent said strip from unwinding.
